(19) United States
(12) Patent Application Publication
(10) Pub. No.: US 2018/0198625 A1
(43) Pub. Date: Jul. 12, 2018

(54) METHOD AND AUTHENTICATION SYSTEM FOR AUTOMATIC RE-AUTHENTICATION

(71) Applicant: I.X Innovation Co., Ltd., Apia (WS)

(72) Inventor: Yung-Chao TSENG, New Taipei City (TW)

(21) Appl. No.: 15/868,822

(22) Filed: Jan. 11, 2018

Related U.S. Application Data
(60) Provisional application No. 62/445,506, filed on Jan. 12, 2017.

(51) Int. Cl. H04L 9/32; H04L 29/06; H04L 9/30; H04W 12/04

(52) U.S. Cl. CPC H04L 9/3247; H04W 12/04; H04L 9/30; H04L 63/0428

(57) ABSTRACT

A method for automatic re-authentication is provided. The method includes: transmitting, by a client device, a challenge to a key device; signing, by the key device, the challenge with a digital signature generated by using a private key and transmitting the digital signature of the challenge to the service server when the key device is connected to the client device; receiving, by the service server, the digital signature of the challenge and authenticating the digital signature with a public key stored in the service server; establishing, by the service server, a service connection between the client device and a service provided by the service server to allow the client device to access the service when the digital signature is verified; and performing, by the service server, a re-authentication operation with the client device and the key device according to a connection between the client device and the key device.

### CROSS REFERENCE TO RELATED APPLICATIONS

This application claims priority of U.S. Provisional Patent Application No. 62/445,506, filed on Jan. 12, 2017, the entirety of which is incorporated by reference herein.

### BACKGROUND OF THE INVENTION

### Field of the Invention

The disclosure relates generally to the field of computer systems. More particularly, the present disclosure relates to a method and an authentication system for automatic re-authentication.

### Description of the Related Art

People are performing an increasing number and variety of tasks electronically. Many of these tasks involve sending requests to services available across a network, such as the Internet. In order to ensure that a request submitted by a user is authorized to access a service, or specific actions or data available through those services, the user submitting the request often has to be authenticated by a system providing the service. In many cases, this involves a user providing some type of credentials, such as a username and password pair.

Currently, the system or service may use 2FA with a PKI challenge to authenticate the user, which could validate these credentials. However, when the user leaves a client device unattended (e.g., a computer or a smartphone running a browser, or an app), the system or service has no way to know that the user had left and whether the person now using the client device is still the authenticated user. A hacker may have a much greater chance to gain access to sensitive data stored on the system or service.

Therefore, a method and an authentication system for automatic re-authentication are needed to solve the problems described above.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

A method and an authentication system for automatic re-authentication are provided.

In a preferred embodiment, a method for automatic re-authentication is provided in the disclosure. The method comprises: transmitting, by a client device, a challenge to a key device; signing, by the key device, the challenge with a digital signature generated by using a private key and transmitting the digital signature of the challenge to the service server when the key device is connected to the client device; receiving, by the service server, the digital signature of the challenge and authenticating the digital signature with a public key stored in the service server; establishing, by the service server, a service connection between the client device and a service provided by the service server to allow the client device to access the service when the digital signature is verified; and performing, by the service server, a re-authentication operation with the client device and the key device according to a connection between the client device and the key device, wherein the private key is stored in the key device and corresponds to the public key stored in the service server.

In a preferred embodiment, an authentication system comprises a service server, a client device, and a key device. The service server provides a service and stores a public key. The client device is connected to the service server. The key device is stores a private key corresponding to the public key stored in the service server. The client device transmits a challenge to a key device; the key device signs the challenge with a digital signature generated by using a private key and transmits the digital signature of the challenge to the service server when the key device is connected to the client device. The service server receives the digital signature of the challenge, authenticates the digital signature with a public key stored in the service server and establishes a service connection between the client device and the service provided by the service server to allow the client device to access the service when the digital signature is verified; the service server performs a re-authentication operation with the client device and the key device according to a connection between the client device and the key device.

### BRIEF DESCRIPTION OF DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to the size in actual implementation in order to clearly illustrate the concept of the present disclosure.

FIG. 1 is a schematic diagram of an authorization system in accordance with an embodiment of the present disclosure.

FIG. 2 shows an alternative simplified functional block diagram of a wireless communication device according to one embodiment of the present disclosure.

FIG. 3 is a flow diagram illustrating a method for automatic re-authentication according to an embodiment of the present disclosure with reference to FIG. 1.

FIG. 4 is a flow chart illustrating the service server performing the re-authentication operation with the client device and the key device according to the connection between the client device and the key device according to an embodiment of the present disclosure.

FIG. 5 is a flow chart illustrating the service server determining whether the connection between the client device and the key device exists according to a disconnection message from the client device in accordance with an embodiment of the present disclosure.

### DETAILED DESCRIPTION OF THE INVENTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

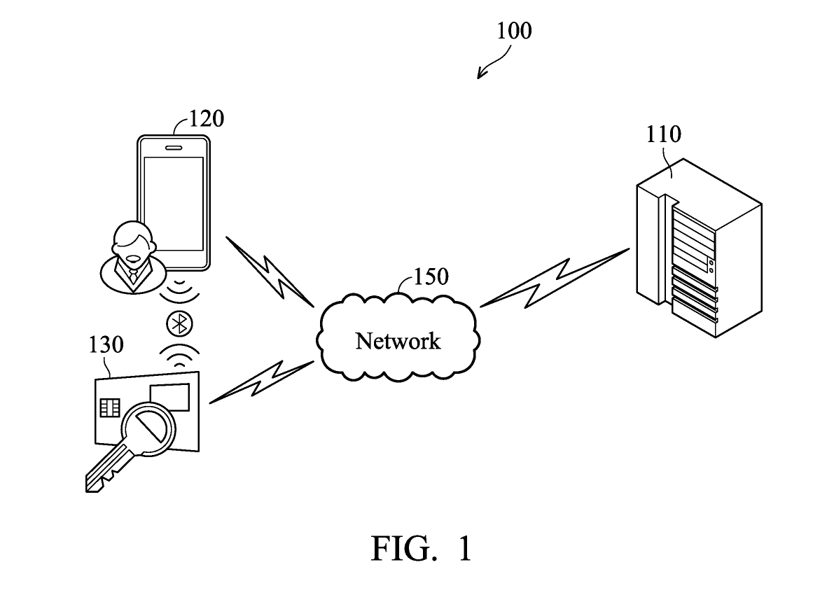

FIG. 1 is a schematic diagram of an authorization system 100 in accordance with an embodiment of the present disclosure.

Referring to FIG. 1, the authentication system 100 in accordance with a preferred embodiment of the present disclosure at least comprises a service server 110, a client device 120, a key device 130 and a network 150. For the authentication system 100, the client device 120 accesses the service server 110 through the network 150 and they exchange necessary information with each other through the network 150.

The service server 110 may employ a wired communications technology (such as LAN, Local Area Network, etc.) or a wireless communications technology (such as WLAN, etc.) to connect to the client device 120 for providing a service to users. The service server 110 may be a desktop computer, a notebook computer, a cloud server or another electronic apparatus with a computation capability.

As described, the service might enable users to use services through their client devices. For example, the service server 110 obtains information from the client device 120 and manages the obtained information. Furthermore, the service server 110 may provide information (e.g., a website) to the client device 120. Such a service may be provided through dedicated applications or web-pages. In order to provide such service, the service server 110 provides at least one of dedicated applications to the client device 120. That is, the client device 120 may download such dedicated applications and installs the downloaded application therein for accessing the service. However, the present disclosure is not limited thereto.

The client device 120 may be an electronic device capable of communicating with other entities through the network 150. For example, the client device 120 may include a personal computer (PC), a smart phone, a laptop computer, a personal digital assistance (PDA), but the present disclosure is not limited thereto.

A user 140 must visit the service server 110 for registration before accessing the service via the client device 120. When the user's identity has already been authenticated by the service server 110, the service server 110 may also use public key Infrastructure (PKI) to perform the function of generating keys of the user 140, wherein the keys are a public key and a private key, and the private key corresponds to the public key. The public key of the user 140 is stored in the service server 110 and the private key of the user 140 is assigned to the key device 130 at manufacture or by a device manufacturer. It should be noted that each of the “device manufacturer,” or the “service provider,” may be referred to as a “key issuer” for providing the keys of the users. In other embodiment, the key device 130 may also use PKI to perform the function of generating the public key and the private key of the user 140, and then transmits the public key to the service server 110.

The key device 130 may be a wireless communication device which can be wirelessly connected to the service server 110 or the client device 120. Specifically, the key device can be wirelessly connected to the client device 120 using short range radio communication technologies including Bluetooth short range connection technology. In addition, the key device 130 may also be implemented in the form of a smart card or implemented as a dongle, and a USB type information protection token, etc. For example, the key device 130 can be implemented as a dongle equipped with a USB port. The USB port can be provided to interface the connection between the dongle and the client device 120.

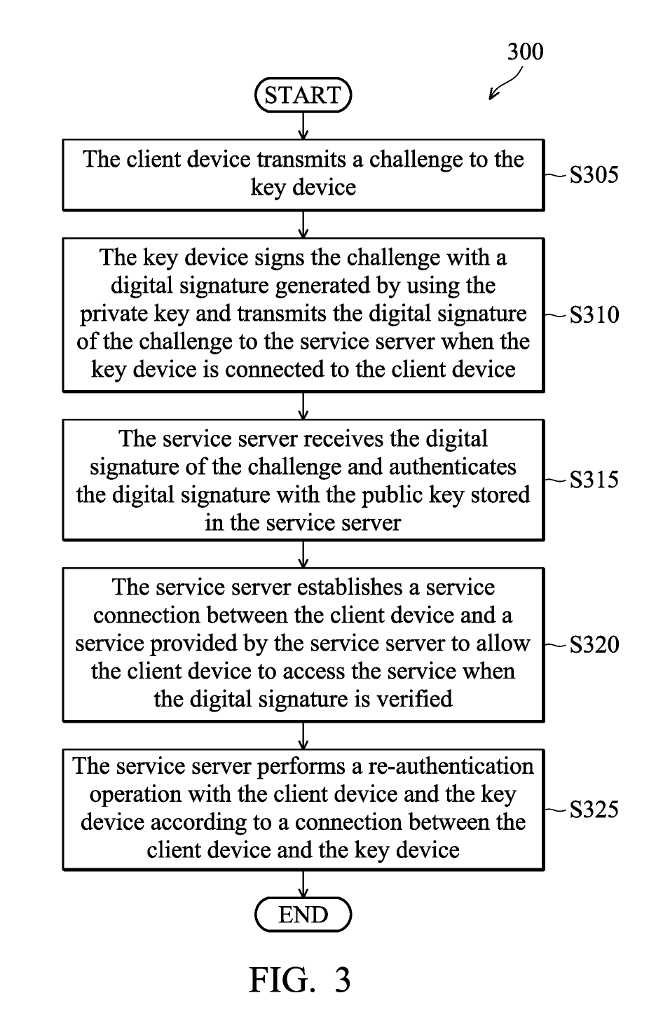

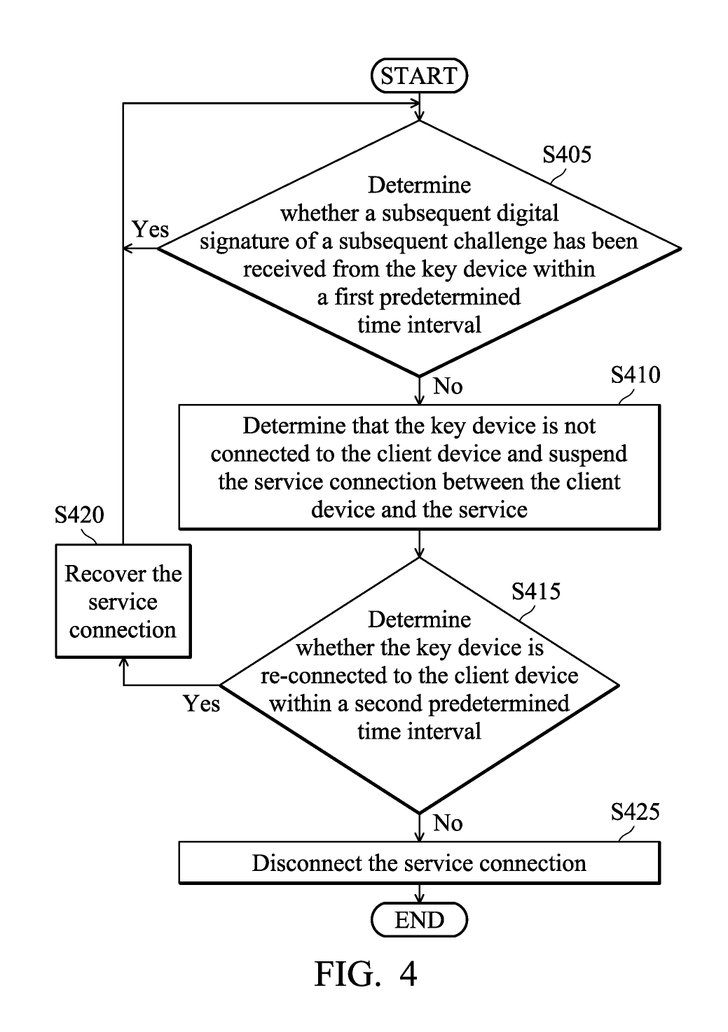

The user 140 uses the client device 120 to access the service with the private key stored in the key device 130. For example, the client device 120 can access the service server 110 through the network 150 via the key device 130. The details of how the client device 120 accesses the service with the private key stored in the key device 130 are shown in and described with reference to FIGS. 3 and 4.

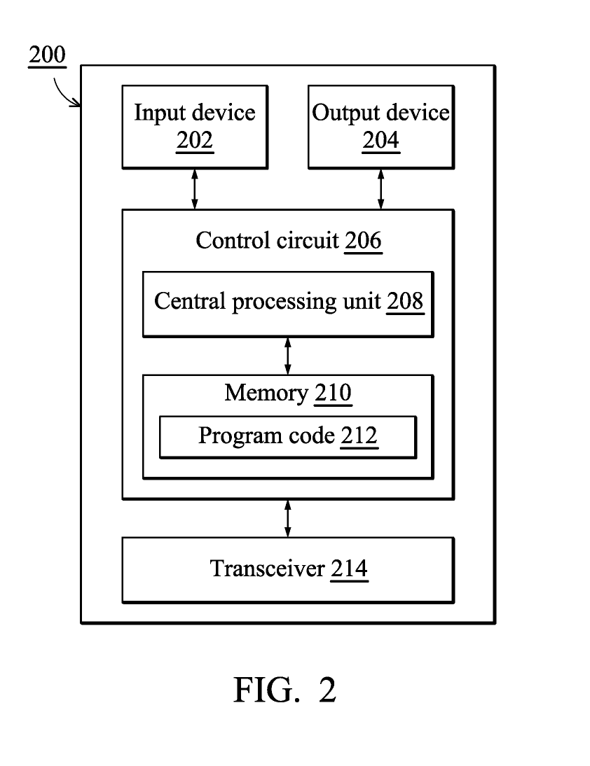

Next, turning to FIG. 2, FIG. 2 shows an alternative simplified functional block diagram of a wireless communication device 200 according to one embodiment of the present disclosure. As shown in FIG. 2, the wireless communication device 200 can be utilized for realizing the client device 120 and the key device 130. The wireless communications device 200 may include an input device 202, an output device 204, a control circuit 206, a central processing unit (CPU) 208, a memory 210, a program code 212, and a transceiver 214. The control circuit 206 executes the program code 212 in the memory 210 through the CPU 208, thereby controlling the operation of the wireless communications device 200. The wireless communications device 200 can receive signals input by a user through the input device 202, such as a keyboard or keypad, and can output images and sound through the output device 204, such as a monitor or speakers. The transceiver 214 is used to receive and transmit wireless signals wirelessly, deliver received signals to the control circuit 206, and output signals generated by the control circuit 206.

FIG. 3 is a flow diagram 300 illustrating a method for automatic re-authentication according to an embodiment of the present disclosure with reference to FIG. 1. The method can be used in the authentication system 100 shown in FIG. 1. Before the procedure, it is assumed that the private key of the user has been stored in the key device and corresponds to the public key stored in the service server.

It should be noted that the user may transmit a log-in request including one or more credentials of the user to the service server via the client device for requesting access to the service provided by the service server before the process of the method is performed. The service server may use the credentials of the user to authenticate the identity of the user. When the user is authorized to access the service by the service server, the process of the method is performed.

In step S305, the client device transmits a challenge to the key device, wherein the challenge may include a timestamp or a random number. In step S310, the key device signs the challenge with a digital signature generated by using the private key and transmits the digital signature of the challenge to the service server when the key device is connected to the client device.

Then, in step S315, the service server receives the digital signature of the challenge and authenticates the digital signature with the public key stored in the service server. Next, in step S320, the service server establishes a service connection between the client device and a service provided by the service server to allow the client device to access the service when the digital signature is verified.

In step S325, the service server performs a re-authentication operation with the client device and the key device according to a connection between the client device and the key device.

In one embodiment, the challenge can be generated and transmitted from the server device to the key device via the client device, and the key device may transmit the digital signature of the challenge to the service server via the client device.

The following manners describe in detail how the service server performs the re-authentication operation with the client device and the key device according to the connection between the client device and the key device in step S325. More specifically, in a case where the client device does not detect whether the connection between the client device and the key device exits, the service server may determine whether subsequent digital signatures of subsequent challenges have been received from the key device to determine whether the key device is connected to the client device. In a case where the client device may detect whether the connection between the client device and the key device does not exit, the service server may determine whether a disconnection message has been received from the client device to determine whether the key device is connected to the client device. FIGS. 4˜5 are flow charts respectively illustrating the service server performing the re-authentication operation with the client device and the key device according to the subsequent digital signatures from the key device and the disconnection message from the client device according to an embodiment of the present disclosure.

As shown in FIG. 4, in step S405, the service server determines whether a subsequent digital signature of a subsequent challenge has been received from the key device within a first predetermined time interval (for example, 60 seconds or some other time interval) by using a first timer, wherein the subsequent digital signature of the subsequent challenge can be authenticated with the public key stored in the service server. When the service server receives the subsequent digital signature of the subsequent challenge from the key device within the first predetermined time interval (“Yes” in step S405), the process returns back to the step S405 and the service server continues to determine whether the subsequent digital signature of the subsequent challenge has been received from the key device within the next first predetermined time interval.

Specifically, when the first timer expires and the service server receives the subsequent digital signature of the subsequent challenge which can be authenticated with the public key stored in the service server within the first predetermined time interval, the service server determines that the key device is connected to the client device so that the service server keeps allowing the client device to access the service. Then, the service server resets the first timer to determine whether the subsequent digital signature of the subsequent challenge has been received within the next first predetermined time interval. In other words, step S405 is repeated at first predetermined time intervals until the service server has not received the subsequent digital signature of the subsequent challenge from the key device within the first predetermined time interval.

When the service server has not received the subsequent digital signature of the subsequent challenge from the key device within the first predetermined time interval (“No” in step S405), in step S410, the service server determines that the key device is not connected to the client device and suspends the service connection between the client device and the service. For example, the user may take the key device to other place far away from the client device so that the key device cannot receive and sign the subsequent challenge with the subsequent digital signature generated by using the private key.

Next, in step S415, the service server determines whether the key device is re-connected to the client device within a second predetermined time interval (for example, 30 seconds or some other time interval), wherein the service server may starts a second timer to countdown the second predetermined time interval. When the key device is re-connected to the client device within the second predetermined time interval (“Yes” in step S415), in step S420, the service server recovers the service connection. Specifically, since the key device is re-connected to the client device within the second predetermined time interval, the key device can sign the subsequent challenge with the subsequent digital signature generated by using the private key stored in the key device and transmit the subsequent digital signature to the service server. When the service server receives the subsequent digital signature of the subsequent challenge and authenticates the subsequent digital signature of the subsequent challenge with the public key, the service server determines that the key device is re-connected to the client device within the second predetermined time interval and recovers the service connection. Next, the process returns back to the step S405 and the service server continues to determine whether the subsequent digital signature of the subsequent challenge has been received from the key device within the next first predetermined time interval.

When the key device is still not connected to the client device after the second predetermined time interval has ended (“No” in step S415), in step S425, the service server disconnects the service connection and the process is ended. For example, the authentication of the user is invalidated automatically when the user carries the key device and leaves the client device. In this situation, even though the user carrying the key device goes back to use the client device, the user still needs to log in the service server again.

In one embodiment, the subsequent challenges may be repeatedly generated and transmitted from the client device to the key device within the first predetermined time intervals. In another embodiment, the subsequent challenges can be repeatedly generated and transmitted from the server device to the key device via the client device within the first predetermined time intervals.

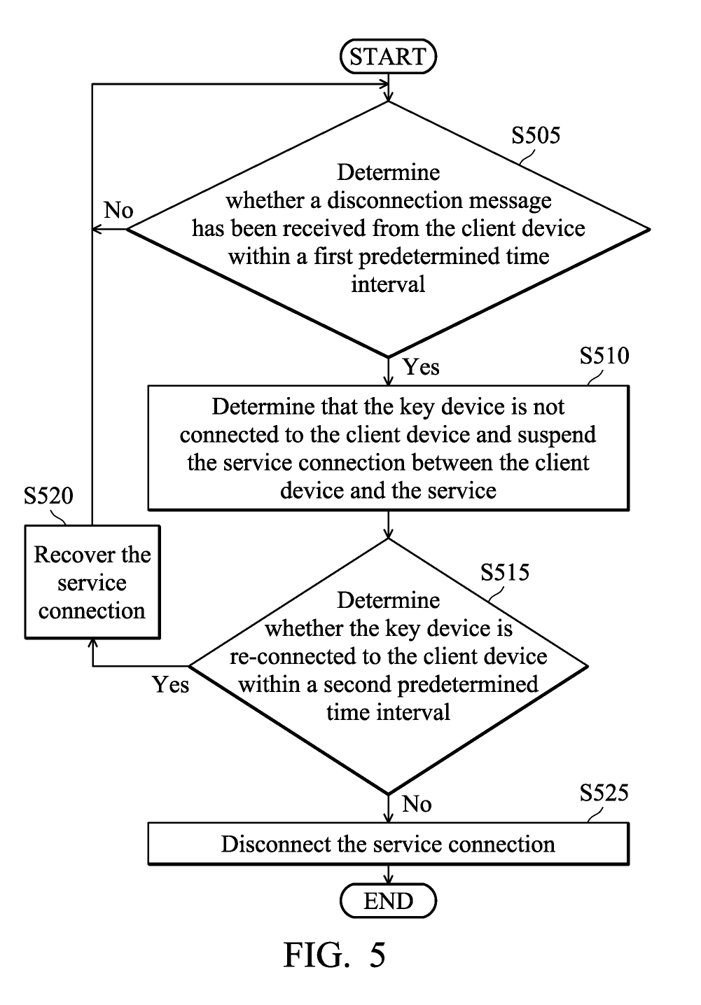

As shown in FIG. 5, the client device may detect whether a connection between the client device and the key device does not exist. In step S505, the service server determines whether a disconnection message has been received from the client device within a first predetermined time interval (for example, 60 seconds or some other time interval) by using a first timer. When the service server does not receive the disconnection message from the client device and receives the subsequent digital signature of the subsequent challenge from the key device within the first predetermined time interval (“No” in step S505), the process returns back to the step S505 and the service server continues to determine whether the disconnection message has been received from the client device within the next first predetermined time interval.

Specifically, when the first timer expires, the service server does not receive the disconnection message, but receives the subsequent digital signature of the subsequent challenge which can be authenticated with the public key stored in the service server. The service server determines that the key device is connected to the client device so that the service server keeps allowing the client device to access the service. Then, the service server resets the first timer to determine whether the disconnection message has been received within the next first predetermined time interval. In other words, step S505 is repeated at first predetermined time intervals until the service server has received the disconnection message from the client device within the first predetermined time interval.

When the service server has received the disconnection message from the client device within the first predetermined time interval (“Yes” in step S505), in step S510, the service server determines that the key device is not connected to the client device and suspends the service connection between the client device and the service. For example, the user may take the key device to other place far away from the client device so that the client device detects that the connection between the client device and the key device does not exist.

Next, in step S515, the service server determines whether the key device is re-connected to the client device within a second predetermined time interval (for example, 30 seconds or some other time interval), wherein the service server may starts a second timer to countdown the second predetermined time interval. When the key device is re-connected to the client device within the second predetermined time interval (“Yes” in step S515), in step S520, the service server recovers the service connection. Specifically, since the key device is re-connected to the client device within the second predetermined time interval, the key device can sign the subsequent challenge with the subsequent digital signature generated by using the private key stored in the key device and transmit the subsequent digital signature to the service server. When the service server receives the subsequent digital signature of the subsequent challenge and authenticates the subsequent digital signature of the subsequent challenge with the public key, the service server determines that the key device is re-connected to the client device within the second predetermined time interval and recovers the service connection. Next, the process returns back to the step S505 and the service server continues to determine whether the disconnection message has been received from the client device within the next first predetermined time interval.

When the key device is still not connected to the client device after the second predetermined time interval has ended (“No” in step S515), in step S525, the service server disconnects the service connection and the process is ended. For example, the authentication of the user is invalidated automatically when the user carries the key device and leaves the client device. In this situation, even though the user carrying the key device goes back to use the client device, the user still needs to log in the service server again.

In one embodiment, the key device can transmit the subsequent digital signatures of the subsequent challenges to the service server via the client device.

In addition, the CPU 208 could execute the program code 212 to perform all of the above-described actions and steps or others described herein.

Therefore, the method and an authentication system for automatic re-authentication provided in the present disclosure can authenticate the user automatically when the user is using the client device to access the service with the private key. In addition, since the service connection between the client device and the service may be disconnected automatically when the user carrying the key device storing the key leaves the client device unattended, the safety of the user can further be increased.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using another structure, functionality, or structure and functionality in addition to or other than one or more of the aspects set forth herein.

Those with skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in ways that vary for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or another programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It should be understood that any specific order or hierarchy of steps in any disclosed process is an example of a sample approach. It should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of exemplary embodiment, it is to be understood that the disclosure is not limited thereto. Those who are skilled in this technology can still make various alterations and modifications without departing from the scope and spirit of this disclosure. Therefore, the scope of the present disclosure shall be defined and protected by the following claims and their equivalents.

What is claimed is:

1. A method for automatic re-authentication, comprising:
transmitting, by a client device, a challenge to a key device;
signing, by the key device, the challenge with a digital signature generated by using a private key and transmitting the digital signature of the challenge to the service server when the key device is connected to the client device;
receiving, by the service server, the digital signature of the challenge and authenticating the digital signature with a public key stored in the service server;
establishing, by the service server, a service connection between the client device and a service provided by the service server to allow the client device to access the service when the digital signature is verified; and
performing, by the service server, a re-authentication operation with the client device and the key device according to a connection between the client device and the key device,
wherein the private key is stored in the key device and corresponds to the public key stored in the service server.

2. The method for automatic re-authentication as claimed in claim 1, wherein the re-authentication operation further comprises:
determining, by the service server, whether a subsequent digital signature of a subsequent challenge has been received from the key device or whether a disconnection message has been received from the client device within a first predetermined time interval, wherein the subsequent digital signature of the subsequent challenge is authenticated with the public key stored in the service server;
determining, by the service server, that the key device is not connected to the client device when the service server has not received the subsequent digital signature of the subsequent challenge or has received the disconnection message within the first predetermined time interval; or
determining, by the service server, that the key device is connected to the client device when the service server receives the subsequent digital signature of the subsequent challenge within the first predetermined time interval.

3. The method for automatic re-authentication as claimed in claim 2, the re-authentication operation further comprising:
keeping, by the service server, allowing the client device to access the service when determining that the key device is connected to the client device within the first predetermined time interval.

4. The method for automatic re-authentication as claimed in claim 2, wherein the re-authentication operation further comprises:
suspending, by the service server, the service connection between the client device and the service when determining that the key device is not connected to the client device within the first predetermined time interval;
determining, by the service server, whether the key device is re-connected to the client device within a second predetermined time interval; and
recovering, by the service server, the service connection when determining that the key device is re-connected to the client device within the second predetermined time interval.

5. The method for automatic re-authentication as claimed in claim 4, wherein the re-authentication operation further comprises:
disconnecting, by the service server, the service connection when the key device is still not connected to the client device after the second predetermined time interval has ended.

6. The method for automatic re-authentication as claimed in claim 1, wherein the challenge is transmitted from the server device to the key device via the client device.

7. The method for automatic re-authentication as claimed in claim 2, wherein a subsequent challenge is transmitted from the client device to the key device.

8. The method for automatic re-authentication as claimed in claim 2, wherein a subsequent challenge is transmitted from the server device to the key device via the client device.

9. The method for automatic re-authentication as claimed in claim 2, wherein the key device transmits the subsequent digital signature of the subsequent challenge back to the service server via the client device.

10. The method for automatic re-authentication as claimed in claim 1, wherein the key device is card-type, dongle-type or USB-type.

11. The method for automatic re-authentication as claimed in claim 1, wherein the key device is a wireless communication device which is wirelessly connected to the client device using short range radio communication technologies including Bluetooth short range connection technology.

12. An authentication system, comprising:
a service server, providing a service and storing a public key;
a client device, connected to the service server; and
a key device, storing a private key corresponding to the public key stored in the service server;
wherein the client device transmits a challenge to a key device; the key device signs the challenge with a digital signature generated by using a private key and transmits the digital signature of the challenge to the service server when the key device is connected to the client device; and
wherein the service server receives the digital signature of the challenge, authenticates the digital signature with a public key stored in the service server and establishes a service connection between the client device and the service provided by the service server to allow the client device to access the service when the digital signature is verified; the service server performs a re-authentication operation with the client device and the key device according to a connection between the client device and the key device.

13. The authentication system as claimed in claim 12, wherein the re-authentication operation performed by the service server further comprises:
determining whether a subsequent digital signature of a subsequent challenge has been received from the key device or whether a disconnection message has been received from the client device within a first predetermined time interval, wherein the subsequent digital signature of the subsequent challenge is authenticated with the public key stored in the service server;
determining that the key device is not connected to the client device when the service server has not received the subsequent digital signature of the subsequent challenge or has received the disconnection message within the first predetermined time interval; or
determining that the key device is connected to the client device when the service server receives the subsequent digital signature of the subsequent challenge within the first predetermined time interval.

14. The authentication system as claimed in claim 13, wherein the re-authentication operation performed by the service server further comprises:
keeping, by the service server, allowing the client device to access the service when determining that the key device is connected to the client device within the first predetermined time interval.

15. The authentication system as claimed in claim 13, wherein the re-authentication operation performed by the service server further comprises:
suspending the service connection between the client device and the service when determining that the key device is not connected to the client device within the first predetermined time interval;
determining whether the key device is re-connected to the client device within a second predetermined time interval; and
recovering the service connection when determining that the key device is re-connected to the client device within the second predetermined time interval.

16. The authentication system as claimed in claim 15, wherein the re-authentication operation performed by the service server further comprises:
disconnecting the service connection when the key device is still not connected to the client device after the second predetermined time interval has ended.

17. The authentication system as claimed in claim 12, wherein the challenge is transmitted from the server device to the key device via the client device.

18. The authentication system as claimed in claim 13, wherein a subsequent challenge is transmitted from the client device to the key device.

19. The authentication system as claimed in claim 13, wherein a subsequent challenge is transmitted from the server device to the key device via the client device.

20. The system for automatic re-authentication as claimed in claim 13, wherein the key device transmits the subsequent digital signature of the subsequent challenge back to the service server via the client device.

21. The authentication system as claimed in claim 12, wherein the key device is card-type, dongle-type or USB-type.

22. The authentication system as claimed in claim 12, wherein the key device is a wireless communication device which is wirelessly connected to the client device using short range radio communication technologies including Bluetooth short range connection technology.
